(19) United States
(12) Patent Application Publication
(10) Pub. No.: US 2023/0081730 A1
(43) Pub. Date: Mar. 16, 2023

(54) CABLE PROCESSING DEVICE AND METHOD

(71) Applicant: MD Elektronik GmbH, Waldkraiburg (DE)

(72) Inventors: Christoph Riegl, Reichertsheim (DE); Josef Ohni, Waldkraiburg (DE)

(21) Appl. No.: 17/889,056

(22) Filed: Aug. 16, 2022

(30) Foreign Application Priority Data
Sep. 16, 2021 (EP) 21197230.2

(51) Int. Cl. G06T 7/00

(52) U.S. Cl. CPC G06T 7/0004; G06T 2207/20081; G06T 2207/30108

(57) ABSTRACT

The present invention comprises a cable processing device comprising first receiving device adapted to receive and fix a first cable end of a cable) in a predetermined position, an image recording device which is designed to capture at least one image of the first cable end, and an evaluation device which is designed to apply a trained algorithm to the at least one image, and to generate and output a control signal on the basis of at least one result output by the trained algorithm, wherein the trained algorithm is adapted to identify a predetermined feature in the at least one image, respectively, and to output a positive result if the predetermined feature is identifiable in the image. Further, the present invention discloses a corresponding method.

### CROSS-REFERENCE TO RELATED APPLICATION(S)

The present disclosure claims priority to European Patent Application No. 21197230.2 filed Sep. 16, 2021. The aforementioned patent application is herein incorporated by reference in its entirety.

### TECHNICAL FIELD

The invention relates to a cable processing device and a method for automatically processing cables, in particular data cables.

### PRIOR ART

The present invention is described mainly in connection with the manufacture of data cables. However, it will be understood that the present invention can be used for the manufacture of any type of cable.

In the manufacture of data cables, the cables are typically processed in an automated processing plant and, for example, assembled, that is, cut to the appropriate length and provided with appropriate electrical contacts and/or connectors. A single automated processing plant thereby comprises several stations, with a defined processing step being carried out at each station.

In order to enable error-free processing of such cables in large quantities, the cables must be checked in the respective processing plant for correct implementation of the individual processing steps. In particular, it is necessary within a particular processing plant to check the cables fed to this station or leaving this station before individual stations to determine whether the cables meet predefined requirements in order to be able to be processed further.

For this purpose, it is known to detect and evaluate the cables during processing at individual stations by means of image recognition. Known image recognition systems should be able to reliably recognize different types of cables under possibly changing lighting conditions. This is difficult to achieve with known image recognition systems.

EP 3 855 359 A1 shows a cable processing station in which an Al module performs semantic segmentation of an image of a cable. In “A machine learning based quality control system for power cable manufacturing” by Hanhirova Jussi et al. a system for detecting defects on the surface of cables using machine learning algorithms is disclosed. “Wire Defect Recognition of Spring-Wire Socket Using Multitask Convolutional Neural Networks,” IEEE TRANSACTIONS ON COMPONENTS, PACKAGING AND MANUFACTURING TECHNOLOGY, IEEE, USA, Vol. 8, No. 4, Apr. 1, 2018 discloses a system for testing spring-wire contacts that employs a so-called Convolutional Neural Network, CNN.

### DESCRIPTION OF THE INVENTION

It is therefore an object of the present invention to improve a process monitoring system in automated cable assembly.

The object is solved by the objects of the independent claims. Advantageous further embodiments of the invention are indicated in the dependent claims, the description and the accompanying figures. In particular, the independent claims of one category of claims may also be further developed analogously to the dependent claims of another category of claims.

A cable processing device according to the invention has a first receiving device, which is designed to receive a first cable end of a cable and to fix it in a predetermined position, an image recording device, which is designed to record at least one image of the first cable end, and an evaluation device which is designed to apply a trained algorithm to the at least one image, and to generate and output a control signal on the basis of at least one result output by the trained algorithm. The trained algorithm is thereby designed to identify a respective predetermined feature in the at least one image and to output a positive result if the predetermined feature is identifiable or identified in the image. In particular, the trained algorithm is designed to identify the predetermined feature in the directly captured image. Further, the trained algorithm is adapted to output a negative result if the predetermined feature is not identifiable in the image. The evaluation device is further configured to apply the trained algorithm directly to the captured at least one image, such that the trained algorithm evaluates the at least one image itself and the at least one image does not need to undergo any downstream image processing before the at least one image can be evaluated.

A method according to the invention for automatically processing cables comprises: Fixing at least one cable end of a cable in a predetermined position, taking at least one image of the at least one cable end, applying a trained algorithm to the at least one image, the trained algorithm being designed to identify a predetermined feature in each case in the at least one image and to output a positive result if the predetermined feature is identifiable in the image or is identified in the image and to output a negative result if the predetermined feature is not identifiable in the image, the trained algorithm being applied directly to the recorded at least one image, so that the trained algorithm evaluates the at least one image itself and the at least one image does not have to be subjected to any downstream image processing before the at least one image can be evaluated. Furthermore, the method according to the invention comprises generating and outputting a control signal based on at least one result output by the trained algorithm. In particular, it is provided that the trained algorithm is applied directly to the captured at least one image, so that the trained algorithm evaluates the raw data itself and the raw data (the directly captured image) does not need to undergo any downstream image processing before the image can be evaluated.

The present invention is based on the realization that conventional image processing systems have little flexibility and can easily misidentify defect-free components as defective components.

For example, with conventional image processing systems, a component that has been rotated or not photographed at the exact predetermined position may already be identified as defective, even if it has no defects.

The present invention therefore provides for replacing a conventional image processing system with a trainable algorithm, i.e., an algorithm from the field of artificial intelligence, and performing defect detection with the aid of the trainable algorithm. Consequently, a conventional image processing system is not required. It is understood that a trainable algorithm and the mentioned trained algorithm may be the same algorithm. In this context, the term “trainable” algorithm refers to any form of the algorithm, while the term “trained” algorithm refers to the algorithm after undergoing training by means of a corresponding training data set.

Unlike very rigidly operating conventional image processing systems, trainable algorithms can typically respond flexibly to changing conditions and still successfully perform the given object. For example, an appropriately trained algorithm can typically detect a given object in an image regardless of its position or the illumination in the image. In contrast, conventional image processing systems typically rely on placing the corresponding object at a precisely predetermined position with a predetermined orientation in the image in order to examine it.

Therefore, the present invention provides a cable processing device comprising a first receiving device that picks up a first cable end of a cable at a predetermined position. An image recording device captures at least one image of the first cable end of the cable. Finally, an evaluation device applies a trained algorithm to the at least one image to determine the presence of a predetermined feature at the first cable end of the cable. In particular, it is provided that the evaluation device applies the trained algorithm directly to the at least one image, i.e., to the raw data that does not need to be subjected to any additional processing or image processing before being evaluated in the evaluation device or after being evaluated in the evaluation device.

In one embodiment, the evaluation device may be designed as hardware, software or a combination of hardware and software. Such an evaluation device may be designed, for example, as an ASIC, FPGA, CPLD or the like. Alternatively, such an evaluation device may be formed, for example, as a computer program product, which is executed by a processor, for example in a computer. In particular, the trained algorithm may be formed, e.g., based on the framework (software package) Tensorflow.

If the predetermined feature is present in a corresponding image at the first cable end of the cable, or if the predetermined feature is positively identified, the trained algorithm outputs a corresponding result, e.g., a positive result. If the trained algorithm cannot identify the predetermined feature in the corresponding image at the first cable end of the cable, the trained algorithm may output a corresponding negative result. It is understood that a trained algorithm may output a result vector, where the number of elements of the vector, corresponds to the number of features to be identified by the trained algorithm. Consequently, in an embodiment in which the trained algorithm has only a single feature to identify, the vector may have only one element. A “positive” result may be a value that is above a predetermined threshold. For example, each output element of the vector may have a predetermined range of values, such as 0-255 or 0-1 or the like. For example, for a vector with only one element, an output may be considered positive if its value is greater than the center of the range of values, or a predetermined threshold. For a vector with several elements, the element with the largest value can be considered the “positive” result. The predetermined feature associated with the corresponding element is then considered to be positively identified. Of course, a threshold value can also be specified for such an element.

The evaluation device subsequently generates a corresponding control signal from the output of the trained algorithm and outputs it to control the cable processing device accordingly. In the cable processing device, the control signal may, for example, cause a cable to be treated as a reject or defective if the predetermined feature is not identified at the cable end. On the other hand, if the predetermined feature is identified at the cable end of the cable, the control signal may cause the cable to be fed to the next processing step. Generating the control signal may also comprise, as a (sub)step, merely forwarding the positive or negative control signal. The forwarded positive or negative control signal can subsequently be converted by a control unit of the cable processing device into control signals for the individual components of the cable processing device. Alternatively, the evaluation unit can generate corresponding control commands for the individual components of the cable processing device from the positive or negative control signal. In any case, after the trained algorithm has been applied to the image, no further evaluation of the image and/or no further evaluation of the positive or negative control signal need to be performed. In particular, the positive or negative control signal directly indicates whether the predetermined feature has been identified or not.

In a processing plant for cables, a cable processing device according to the present invention may be arranged in, before or after different, in particular also several, processing steps.

It is understood that the trained algorithm is based on a trainable algorithm which has undergone a corresponding training. In the course of such training, the trainable algorithm may be presented with corresponding training data, which has already been divided in advance into positive and negative training examples. Such a training dataset can, for example, be created manually or obtained from the results of a conventional image processing system.

In the following, a possible embodiment for creating a training data set and training the trainable algorithm is described. It is understood that the described creation and training may also be used independently of the cable processing device. The present disclosure therefore explicitly discloses such creation and corresponding training as separate objects.

For training the trainable algorithm, a corresponding set of training images is generated. In this regard, the images show positive and negative examples, i.e., cable ends of cables, which may or may not exhibit the respective predetermined feature. These training images are qualified as positive and negative training images. This qualification can be done by hand or at least partially by a conventional image processing system, where manual rework is possible.

The pre-qualified training images are subsequently pre-processed accordingly for training.

For example, the size of the training images can be adjusted to a predetermined size. In particular, the number of pixels of the training images may be adapted to the number of inputs of an input layer of the trainable algorithm. For example, in one embodiment, the trainable algorithm may process square images of a predetermined size.

The preprocessing of the training images may also comprise normalizing the images. For example, the images may be converted to grayscale images if they are not available as such. Further, the maximum and minimum grayscale values of each training image may be adjusted so that the grayscale values of all training images fall within a predetermined range.

Furthermore, in order to improve or make more robust the results to be obtained with the trainable algorithm, the training images can be subjected to random image manipulations. Such image manipulations may include, for example, rotating, zooming in, zooming out, and/or distorting. It is understood that appropriate magnitudes may be specified for the respective image manipulation. For example, for zooming in or out, a maximum magnification or reduction can be specified as a percentage, e.g., 110% or 90%. For rotation, for example, a maximum or minimum rotation angle can be specified, e.g. +/−10°, 20° or 30°. Likewise, appropriate limits can be specified for distortion. It is understood that different algorithms can be used for image distortion, which can have different parameters.

The image manipulations are used to provide the training data with a larger variability. Consequently, the given feature will be present in the positive training images at different locations and in different sizes. This prevents, for example, the trainable algorithm from learning to identify the given feature only in a small section of an image and incorrectly concluding that the feature is not present, even though it is, for example, merely outside the section.

After preprocessing the training images, the trainable algorithm is trained with a portion of the training images thus obtained, also called training data. The remaining training images can be used to check the learning success by feeding them to the trained algorithm and comparing its output with the output known or expected for the respective training image. This portion of the training images can therefore be referred to as test data.

It is understood that training can be performed differently depending on the type of trainable algorithm used. Basically, in any type of training, the parameters of the trainable algorithm are adjusted during each training run so that the error of the output of the trainable algorithm is minimized. This is usually achieved by a so-called back-propagation, error back-propagation or back-propagation.

Furthermore, a so-called number of epochs and a termination criterion can be specified for the training. The number of epochs specifies the number of training runs. For each training run a predefined number of training data can be used, e.g. all training data or only a selection of training data. The termination criterion specifies how far the result of the trainable algorithm may deviate from the ideal result in order to consider the training as successfully completed.

Depending on the type of trainable algorithm, further training parameters can be specified. For example, for a neural network, the initial weights of the individual neurons and a learning rate can be specified.

After completion of the training, the quality of the training can be checked by means of a qualification of the test data by the trained algorithm, as mentioned above. If the results reach the desired quality, the training can be terminated. If the results do not reach the desired quality, the training can be continued or performed again with modified parameters.

A cable processing device whose evaluation device uses an algorithm trained in this way to evaluate or assess images of cable ends can determine with a high degree of certainty whether or not the respective cable end of a cable has the predetermined feature. Consequently, quality assurance can be increased when processing cables with such a cable processing device.

It is understood that the predetermined feature may be an explicit feature, that is, a feature which may be present or absent. Such an explicit feature may be, for example, a marking or a connecting element at the cable end of the cable. However, the given feature may also be an implicit feature, i.e., a feature that identifies a state. Such an implicit feature may, for example, identify the state of a latch on a connecting element at the cable end of the cable.

Further embodiments and further embodiments will be apparent from the subclaims and from the description with reference to the figures.

In one embodiment, the cable processing device may comprise a second receiving device configured to pick up a second cable end of the cable and fix it in a predetermined position. In such an embodiment, the image recording device may be further configured to record at least one image of the second cable end.

A cable typically has two cable ends, although Y-type cables may also have three or more cable ends. However, data cables for high data rates in particular are typically used in point-to-point connections and consequently have two cable ends.

In a processing system for such cables, it may be important not only to check for the presence of a feature, but additionally to check at which cable end of the cable a feature is present. In further embodiments, it may alternatively be checked whether the predetermined feature is present at both cable ends of the cable.

Consequently, if the cable processing device has two receiving devices, both cable ends of a cable can be picked up and examined simultaneously in the cable processing device. It is understood that the two receiving devices may be configured to be passed between processing steps in the cable processing device. Thus, the receiving devices can receive and fix the cable ends permanently, for several processing steps.

If two cable ends of a cable are fed to the cable processing device, different checks can be carried out.

If it must be ensured that a certain cable end of a cable is located in a certain one of the receiving devices and if this cable end is marked by a feature, the cable processing device can be used to check whether the feature is present on the cable end of the cable which is fixed in the receiving device which is to have the corresponding cable end.

If, on the other hand, it must be ensured that both cable ends of the cable have a predetermined feature, the cable processing device can be used to check whether both cable ends of the cable have the predetermined feature. If it is the same feature, the trainable algorithm does not need to be trained for each cable end individually. Rather, the trained algorithm can be applied to the images of each cable end in turn and the outputs of the algorithm evaluated accordingly.

In a further embodiment, the image recording device may comprise a first camera configured to capture images in a top view of the respective cable end.

If the images of the cable ends are taken in a top view, a single image can be used to capture half the sheath surface of the respective cable end. A marking at the cable end, which comprises a larger area than half the sheath area, can thus be reliably detected with this single image.

In still another embodiment, the image recording device may comprise a second camera which is designed to capture images in a perspective view of the respective cable end. In this context, the term “perspective view” refers to a position of the second camera which is arranged offset by a predetermined angle about the longitudinal axis of the cable end with respect to the first camera. This angle may be, for example, an angle greater than 0° and less than 90°. It is understood that the recording or imaging direction of the second camera is directed towards the cable end.

With the aid of the second camera arranged in perspective, one image can be recorded in each case from a perspective view of the cable end. Consequently, with the help of the two images, markings on the cable end can be detected even if they are smaller than half the sheath area.

In one embodiment, the trained algorithm may comprise a neural network, in particular a Convolutional Neural Network, CNN, or deep Convolutional Neural Network, dCNN. Especially for the classification of objects in image data, CNNs and dCNNs provide very good results. It is understood that other machine learning algorithms are also possible.

An exemplary neural network may, for example, be designed as a deep convolutional neural network and have an input layer as well as a plurality of hidden layers and an output layer. The hidden layers may have at least partially identical or repeating layers.

The input layer may have an input for each pixel of the captured images. It is understood that the images may be transmitted to the input layer, for example, as an array or vector with the appropriate number of elements. Further, the size of the captured images may be the same for all images. For example, the images may be captured with 224*224 pixels and have a grayscale value per pixel. It is understood that this information is provided by way of example only, and other resolutions and black and white or color images may be used.

One such layer may be the first layer of the neural network (the names of the respective layer in the Tensorflow/keras software package are given in parentheses, but for clarity the component “tensorflow.python.keras . . . ” is not included):

Layer 1: Input (“engine.input_layer.InputLayer”) (as an example of generally an input layer or input layers).

The hidden layers can perform some kind of preparation of the input data and then process it further in a number of identical blocks. These layers can be, for example, layers for padding with zeros, so-called zero padding layers, layers for a convolution, layers for a normalization, and layers for activation, in particular by means of a so-called ReLU function, also called rectified linear unit.

An exemplary layer structure of such layers for the preparation of the data can be as follows (in brackets the names of the respective layer in the software package Tensorflow/keras are indicated, whereby for the sake of clarity the component “tensorflow.python.keras . . . ” is not indicated):

Layer 2: Zero Padding (“layers.convolutional.ZeroPadding2D”).

layer 3: Convolution (“layers.convolutional.Conv2D”)

Layer 4: Normalization (“layers.normalization_v2.BatchNormalization”)

Layer 5: Activation (“layers.advanced_activations.ReLU”)

Layer 6: Convolution (“layers.convolutional.DepthwiseConv2D”)

Layer 7: Normalization (“layers.normalization_v2.BatchNormalization”)

Layer 8: Activation (“layers.advanced_activations.ReLU”)

Layer 9: Convolution (“layers.convolutional.Conv2D”)

Layer 10: Normalization (“layers.normalization_v2.BatchNormalization”)

It is understood that different layer arrangements are possible and the above structure is only shown as an example.

These layers can be followed by blocks, each of which can have an identical structure. Each of the blocks can, for example, have layers for convolution, for normalization, for activation, in particular by means of a so-called ReLU function, also called rectified linear unit, and for padding, in particular so-called zero padding.

An exemplary layer structure of such a block can be as follows (in brackets the names of the respective layer in the software package Tensorflow/keras are indicated, whereby for the sake of clarity the component “tensorflow.python.keras . . . ” is not indicated):

Layer 11: Convolution (“layers.convolutional.Conv2D”).

Layer 12: Normalization (“layers.normalization_v2.BatchNormalization”)

Layer 13: Activation (“layers.advanced_activations.ReLU”)

Layer 14: Zero Padding (“layers.convolutional.ZeroPadding2D”)

Layer 15: Convolution (“layers.convolutional.DepthwiseConv2D”)

Layer 16: Normalization (“layers.normalization_v2.BatchNormalization”)

Layer 17: Activation (“layers.advanced_activations.ReLU”)

Layer 18: Convolution (“layers.convolutional.DepthwiseConv2D”)

Layer 19: Normalization (“layers.normalization_v2.BatchNormalization”)

It is understood that different layer arrangements are possible and the above structure is shown only as an example. An exemplary trainable algorithm can have e.g. 10-20, in particular 14-18 or 16 such blocks.

The blocks may be followed by further hidden layers. An exemplary layer structure may be as follows (the names of the respective layer in the Tensorflow/keras software package are given in parentheses, although the component “tensorflow.python.keras . . . ” is not included for clarity):

Layer 20: Convolution (“layers.convolutional.DepthwiseConv2D”).

Layer 21: Normalization (“layers.normalization_v2.BatchNormalization”)

Layer 22: Activation (“layers.advanced_activations.ReLU”)

Layer 23: Pooling (“layers.pooling.GlobalAveragePooling2D”)

It is understood that different layer arrangements are possible and the above structure is only shown as an example.

The output layer follows the hidden layers and is the last layer of the neural network (in parentheses the names of the respective layer in the software package Tensorflow/keras are indicated, whereby for the sake of clarity the component “tensorflow.python.keras . . . ” is not indicated):

Layer 24: Output (“layers.core.Dense”).

Consequently, a neural network according to the above with e.g., 16 blocks, has an input layer, nine layers for data preparation, 9*16 layers of blocks, 4 hidden layers and an output layer, i.e. 159 layers.

In another embodiment, the predetermined feature may have a marker at the cable end. The trained algorithm may be trained to identify this predetermined mark at the cable end.

When processing cables, individual ends of a cable are often provided with a marking. This marking may be referred to, for example, as a so-called A-marking. Such a marking may be formed, for example, as a square or rectangle which contrasts in color with the material of the cable sheath and covers a predetermined circumferential portion of the sheath surface of the cable sheath.

As another example, the predetermined feature may also be a printing, wherein the printing, for example a text or number sequence, is applied by the manufacturer of the cable to be processed, and wherein the trained algorithm may be trained to identify the presence or absence of such printing.

The training necessary to generate the trained algorithm from a trainable algorithm may be performed based on a predetermined set of training data. One possible embodiment of such training has already been indicated above. It is understood that the training data set may have a plurality of images showing cable ends that may or may not have the respective marker, each of the images additionally having information as to whether or not it shows the respective marker.

In an embodiment in which the predetermined feature may have a marking (or a printing—the explanations made below for a marking apply mutatis mutandis in the case of a printing), the cable processing device may have two receiving devices and the image recording device may have two cameras. This makes it possible to take two images of each of the two cable ends that are fixed in the two receiving devices, one from a top view and one from a perspective view, and then to analyze them. In total, four images can be recorded.

In yet another embodiment, the evaluation device can be designed to output a positive control signal, and in particular to output precisely a single positive control signal, if the predetermined marker is identified at exactly one cable end in the images of one of the two cameras, and to output an error signal if the predetermined marker is not identified at exactly one cable end in the images of one of the two cameras.

In such an embodiment, the four images can be analyzed sequentially by the trainable algorithm. Consequently, four identification results are output. For example, the marking may be such that only one of the images may have the marking. Consequently, checking the analysis results by the evaluation device may involve checking whether the predetermined mark has been identified for only one of the images. If this is the case, a corresponding control signal can be output. The term “positive control signal” refers to a control signal that is output after a positive check of the images. If, in such an embodiment, the mark is not identified in exactly one of the images but, for example, in none or more than one of the images, the evaluation device can output an error signal or negative control signal which identifies the faulty inspection of the cable. The respective cable can then be removed from processing, e.g., as a reject, or sent for manual re-testing or rework.

The evaluation device can further be designed to check in which of the images the marking was detected. Thus, for example, it can be checked whether the marking was detected in the image that the first camera captured of the first cable end.

In such an embodiment, the trainable algorithm may output a vector with only one element indicating whether the predetermined marker was detected in the respective image. Alternatively, the trainable algorithm may output a vector with two elements, one of the elements indicating that in the respective image the mark has been detected and the other element indicating that in the respective image the mark has not been detected. Thus, only one of the elements may indicate a positive result at any given time.

Alternatively, the trainable algorithm can also be designed in such a way that it additionally analyzes for each image whether the respective image shows a top view of the cable end or a perspective view of the cable end. For this purpose, corresponding additional markings can be provided, for example, at the cable ends or at the receiving devices, which are displayed distorted in a perspective view compared to the top view. Such markings consequently make it possible to identify whether the respective image was recorded in a top view or a perspective view.

In one such embodiment, the trainable algorithm may output a vector with two elements. One of the elements may indicate whether the given marker was detected in the respective image. The second element may indicate whether the respective image was captured in a top view. Alternatively, the trainable algorithm can output a vector with four elements, where two of the elements are complementary to each other, i.e., the two elements of one pair indicate whether the marker was detected or not, and the two elements of the further pair indicate whether the image was captured in the top view or a perspective view.

In such an embodiment, the evaluation device can check, for example, whether exactly two of the images show a top view and the mark was detected in exactly one of the images.

If it is not only checked whether the marking is present at all in one of the images, but also in which image the marking is present, a conclusion can be drawn about the position or orientation of the cable end and it can be assessed whether the cable is in the correct position or orientation in the respective receiving device.

In one embodiment, the predetermined feature may be formed as a plug or connector located at the respective cable end, and the trained algorithm may be trained to identify the presence of a plug or connector at the cable end.

Cables, in particular data cables, are typically provided with a plug or connector at each end. It is therefore necessary in the processing of such cables to check whether or not the plugs are actually present at the respective cable end after the respective processing steps. Incorrectly attached plugs or connectors may, for example, come loose and fall off the end of the cable, or faulty processing equipment may fail to attach the plug or connector altogether.

The training required to generate the trained algorithm from a trainable algorithm may be performed based on a predetermined set of training data. One possible embodiment of such training has already been indicated above. It is understood that the training data set may have a plurality of images showing cable ends that may or may not have the respective plug or connector, each of the images additionally having information as to whether or not it shows the respective plug or connector.

In one embodiment, the predetermined feature may comprise a locking device and the trained algorithm may be trained to identify the presence of a locking device, in particular a contact locking device, at the cable end.

As discussed above, the trained algorithm may be provided with an image of a cable end. The trained algorithm may be trained to identify as the given feature an locking device. Such a locking device may be, for example, a locking device on a connector or plug.

Especially in industrial applications or automotive applications, cables are usually secured against accidental disconnection with a locking device. Such a locking device may be provided on the respective connector or plug in the form of a latching element, a bracket or the like.

Furthermore, individual contacts, each arranged on cores of a multicore cable, can also be secured against slipping out of a connector housing. Such a locking device is also called a secondary locking device or a contact locking device or a contact locking device. A contact locking device can, for example, engage positively in the individual contacts, e.g. by means of corresponding pins, lugs or hooks, and fix them in the respective position.

Depending on the embodiment, the locking device can be mounted independently of the respective connector or connection element. In particular for such locking devices, a separate check for the presence of the locking device may be advantageous.

The trained algorithm may be appropriately trained to identify the locking device in an image at a time, and to provide a corresponding output indicating whether or not the locking device has been identified in the respective image.

The training necessary to generate the trained algorithm from a trainable algorithm may be performed based on a predetermined set of training data. One possible embodiment of such training is already given above. It is understood that the training data set may have a plurality of images showing cable ends that may or may not have the respective locking device, each of the images additionally having information as to whether or not it shows the respective locking device.

In one embodiment, the evaluation device may therefore be designed to output a positive control signal if the locking device is identified in at least one of the images, and to output an error signal if the predetermined marking is not identified in at least one of the images.

The evaluation device may evaluate two images of each of the cable ends, i.e., an image taken in a top view and an image taken in a perspective view, to determine whether a locking device is present at the respective cable end. The evaluation device may qualify the locking device as present, for example, if according to the trained algorithm the locking device is present in at least one of the images. Alternatively, it may also be required that according to the trained algorithm the locking device is present in both images.

It is understood that the evaluation device may evaluate one or both cable ends depending on whether a locking device should be present at one or both cable ends.

In yet another embodiment, the predetermined feature may identify the state of a locking device and the trained algorithm may be trained to identify the state of a locking device, particularly a contact locking device, at the cable end.

It is understood that not only the presence of a locking device may be relevant in the processing of cables. For example, the state of a locking device is equally relevant. For example, a locking device on a plug or connector may be in an open state or a locked state. Depending on the purpose of the locking device, one of these states may be required.

For example, a contact interlock may be required to be closed after a processing step. In contrast, it may be required, for example, that a locking device for interlocking two plugs or connectors be open during or at the end of the processing of the cable, since it is only closed in the respective application.

Consequently, the trained algorithm may be trained to detect and output the state of a locking device. For example, such a trained algorithm may output a vector with an element indicating whether the locking device is open or locked. Alternatively, an algorithm trained in this manner may output a vector with two complementary elements, one of which indicates that the locking device is open and one of which indicates that the locking device is closed.

The training necessary to generate the trained algorithm from a trainable algorithm may be performed based on a predetermined set of training data. One possible embodiment of such training has already been indicated above. It is understood that the training data set may comprise a plurality of images showing cable ends, each showing the locking device in an open or locked state, each of the images additionally having information as to whether it shows the locking device in an open or locked state.

In a further embodiment, the evaluation device can be designed to output a positive control signal if the state of the locking device in at least one of the images is identified as a locked state, and to output an error signal if the state is not identified as a locked state. Alternatively, the evaluation device may be configured to output an error signal when the state of the locking device is identified as a locked state in at least one of the images, and to output a positive control signal when the state is not identified as a locked state.

As explained above, depending on the application and the type of locking device, it may be required that the locking device is in an open or closed state.

The evaluation device may evaluate two images of each of the cable ends, i.e., an image taken in a top view and an image taken in a perspective view, to determine which state the respective locking device is in. The evaluation device may qualify the locking device as open or closed, for example, if according to the trained algorithm in at least one of the images the locking device is open or closed. Alternatively, it may also be required that according to the trained algorithm in both images the locking device is open or closed.

It is understood that the evaluation device can evaluate one or both cable ends, depending on whether a locking device should be present at one or both cable ends and a corresponding state is specified.

### BRIEF FIGURE DESCRIPTION

Advantageous embodiments of the invention are explained below with reference to the accompanying figures. They show:

FIG. 1 a schematic representation of an embodiment of a cable processing device according to the present invention;

FIG. 2 a schematic representation of another embodiment of a cable processing device according to the present invention;

FIG. 3 a schematic representation of still another embodiment of a cable processing device according to the present invention;

FIG. 4 a schematic representation of a cable end for processing in one embodiment of a cable processing device according to the present invention;

FIG. 5 a schematic representation of a further cable end for processing in one embodiment of a cable processing device according to the present invention;

FIG. 6 a schematic representation of a further cable end for processing in one embodiment of a cable processing device according to the present invention;

FIG. 7 a further representation of the cable end of FIG. 6;

FIG. 8 a schematic representation of a further embodiment of a cable processing device according to the present invention;

FIG. 9 a schematic representation of a further cable end for processing in one embodiment of a cable processing device according to the present invention; and

FIG. 10 a flowchart of an embodiment of a method according to the present invention.

The figures are schematic representations only and are for the purpose of explaining the invention. Identical or like-acting elements are indicated throughout by the same reference numerals.

### DETAILED DESCRIPTION

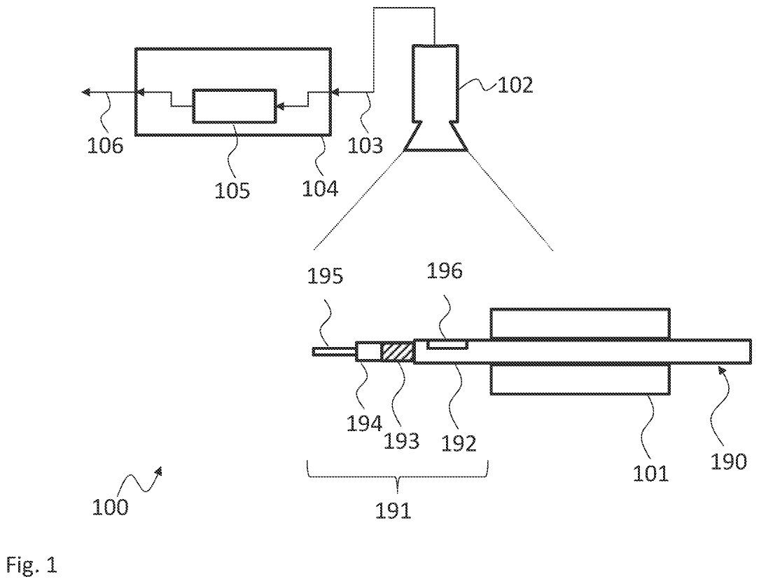

FIG. 1 shows a cable processing device 100. The cable processing device 100 has a first receiving device 101, an image recording device 102 and an evaluation device 104.

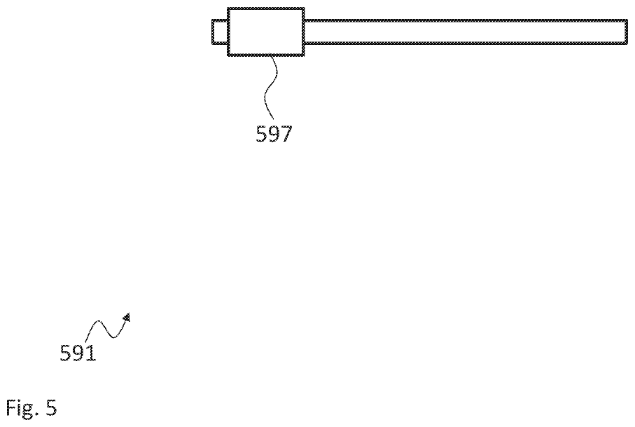

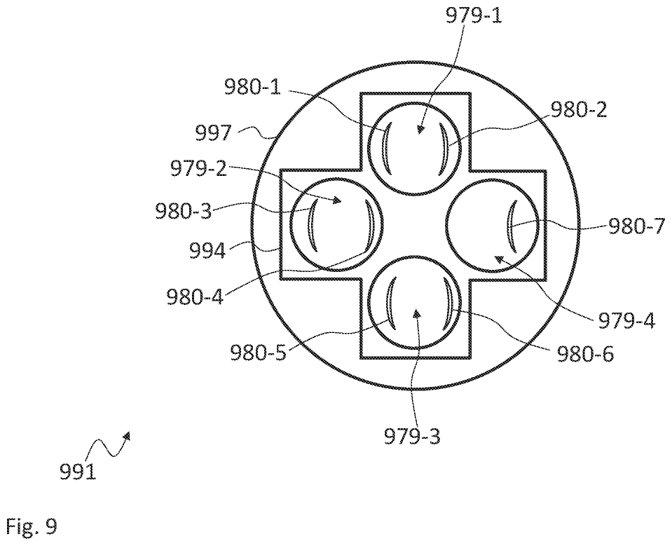

The first receiving device 101 is adapted to receive a first cable end 191 of a cable 190 and to fix it in a predetermined position. FIG. 1 shows an example of a cable 190 having a sheath 192 enclosing a braided shield 193 disposed on an insulator 194. The insulator 194 encloses the conductor 195 of the cable 190. In particular, the cable 190 may be a coaxial cable. It is understood that the cable processing device 100 may be used with any other type of cable as well. A mark 196 is provided on the sheath 192 of the cable 190, the mark 196 representing the feature to be identified by a trained algorithm 105. It is understood that the mark 196 is merely exemplary as a feature to be identified, and that other types of features may also be used. Possible features have been discussed above and are shown in FIGS. 5-7 and 9. Exemplary features for identification by the trained algorithm 105 may comprise, for example, connectors, markings on connectors, in particular codes, locking devices on cable ends or connectors, and in particular the state of such a locking device, as explained in connection with FIGS. 5-7. Other exemplary features may include, for example, contact tongues of connectors and, in particular, the positions of the contact tongues in the connectors, as explained in connection with FIG. 9.

The image recording device 102 captures at least one image 103 of the first cable end 191 and sends the image data to the evaluation device 104. It is understood that typically a single image 103 can be captured of each cable end 191. However, should it be necessary, the image recording device 102 may capture multiple images 103 of the cable end 191.

The evaluation device 104 applies the trained algorithm 105 to the one image 103 and generates a control signal 106 based on a result output from the trained algorithm 105. In particular, it is provided that the evaluation device 104 applies the trained algorithm to the directly captured image 103 or to a partial section of the directly captured image 103. In particular, the evaluation device 104 does not apply any further image processing to the image 103. For providing the partial section of the directly captured image 103, an intermediate program (in particular an image processing software, specifically a publicly available image processing program, for example ‘Eye Vision Technology’ (EVT)) can still be connected between the image recording device 102 and the evaluation device 104, the sole object of which is to crop the directly captured image 103 and to forward only a defined section as a partial section to the evaluation device 104; this task of cropping a partial section from the directly captured image 103 can also be performed within the evaluation device 104. It is understood, however, that the directly captured image 103, not just a partial section, may also be evaluated in the evaluation device 104.

The trained algorithm 105 may, for example, comprise a neural network, in particular a convolutional neural network. This neural network may be formed and trained to identify a predetermined feature 196 in the at least one image 103 and output a positive result if the predetermined feature 196 is identifiable in the image 103. A possible embodiment for such a neural network is already described above. Likewise, a possible training procedure is already described above. In particular, it may be provided that the neural network is designed and trained to identify the predetermined feature 196 in the at least one immediately captured image 103. Thereby, it can be avoided that the directly captured image 103, as raw data, first requires image processing or image evaluation or image analysis in order to be evaluated in a processed form by the neural network in a subsequent step.

The control signal 106 may be evaluated in a cable processing system in which the cable processing device 100 is used, and may influence the further processing of the cable 190. For example, if the control signal 106 indicates that the mark 196 on the jacket has been identified as expected, the next processing step may be initiated. If, on the other hand, the control signal 106 indicates that the marking 196 could not be identified, the cable 190 may be identified as defective, for example, and may be excluded from further processing.

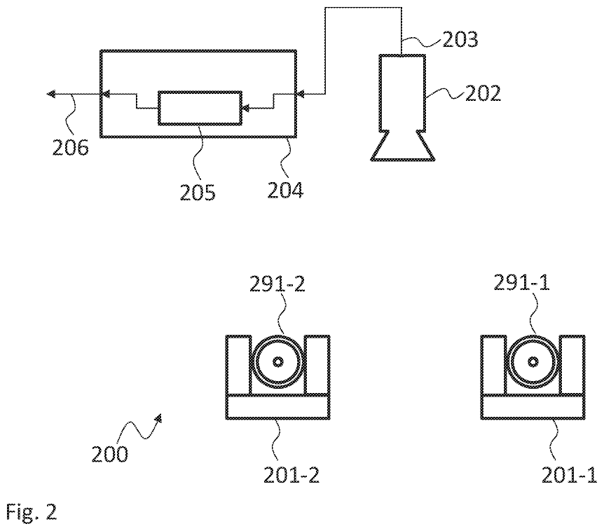

FIG. 2 shows a cable processing device 200. The cable processing device 200 starts from the cable processing device 100 described in more detail in FIG. 1 and continues this in that a second receiving device 201-2 is provided. Consequently, the cable processing device 200 has a first receiving device 201-1, a second receiving device 201-2, an image recording device 202, and an evaluation device 204. The evaluation device 204 further comprises a trained algorithm 205. The above explanations regarding the cable processing device 100 are mutatis mutandis also applicable to the cable processing device 200.

As with the cable processing device 100 described in more detail with reference to FIG. 1, the first receiving device 201-1 receives a first cable end 291-1 of a cable. The second receiving device 201-2 receives a second cable end 291-2 of the cable. Thus, the cable may be clamped in the form of a loop in a cable clamp of a processing device and the two cable ends 291-1, 291-2 may be simultaneously captured and evaluated in the cable processing device 200.

The image recording device 202 captures one or more images 203 of each of the two cable ends 291-1, 291-2 in the cable processing device 200.

The evaluation device 204 may process the images 203 sequentially, thus applying the trained algorithm 205 to each of the images separately, and generating a corresponding control signal 206. With respect to the trained algorithm 205, the above explanations regarding the trained algorithm 105 apply. In particular, it may be provided that the evaluation device 204 applies the trained algorithm 205 to each of the immediately acquired images 203 without applying any further image processing to the images 203.

Consequently, the trained algorithm 205 may be configured to detect a respective mark applied to the sheath of one of the cable ends 291-1, 291-2. Consequently, the respective marking represents the feature to be identified by a trained algorithm 205. It is understood that the marking is merely mentioned as an example of the feature to be identified, and that other types of features may also be used. Possible features have been discussed above and are shown in FIGS. 5-7 and 9. Exemplary features for identification by the trained algorithm 205 may comprise, for example, connectors, markings on connectors, in particular codes, locking devices on cable ends or connectors, and in particular the state of such a locking device, as explained in connection with FIGS. 5-7. Other exemplary features may include, for example, contact tongues of connectors and, in particular, the positions of the contact tongues in the connectors, as explained in connection with FIG. 9.

For example, the evaluation device 204 may generate a positive control signal 206 when exactly one of the two cable ends 291-1, 291-2 has a mark or a predetermined feature. In other embodiments, the evaluation device 204 may generate a positive control signal 206 when both cable ends 291-1, 291-2 have a marking or predetermined feature.

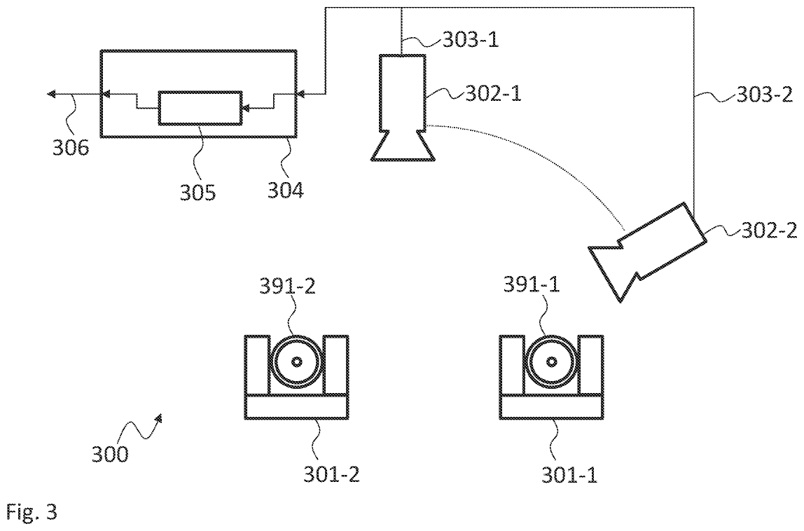

FIG. 3 shows a cable processing device 300. The cable processing device 300 is based on the cable processing device 200 and is an extension thereof in that the image recording device includes a first camera 302-1 and a second camera 302-2. Consequently, the cable processing device 300 has a first image receiving device 301-1, a second image receiving device 301-2, a first camera 302-1, a second camera 302-2, and an evaluation device 304. The evaluation device 304 further comprises a trained algorithm 305. It is understood that the second recording device 301-2 is only optional, and the cable processing device 300 may also have only one receiving device 301-1. The above discussion regarding the cable processing devices 100 and 200 is mutatis mutandis applicable to the cable processing device 300 as well.

The first camera 302-1 captures images 303-1 of the cable ends 391-1, 391-2 from a top view. In contrast, the second camera 302-2 is offset or pivoted about the longitudinal axis of the cable ends 391-1, 391-2 by a predetermined angle relative to the first camera 302-1 and captures images 303-2 of the cable ends 391-1, 391-2 from a perspective view.

For example, with two cable ends 391-1, 391-2 to be examined, the cable processing device 300 may capture four images 302-1, 302-2.

The evaluation device 304 may process the images 303-1, 303-2 one after the other, thus applying the trained algorithm 305 to each of the images separately, and generating a corresponding control signal 306. Regarding the trained algorithm 305, the above explanations on the trained algorithm 105 and 205 apply. In particular, it may be provided that the evaluation device 304 processes the directly captured images 303-1, 303-2, thus applying the trained algorithm 305 to each of the directly captured images, i.e., to the raw data, without performing any further image processing.

For example, the trained algorithm 305 may be configured to recognize a respective mark applied to the sheath of one of the cable ends 391-1, 391-2. Consequently, the respective marking represents the feature to be identified by a trained algorithm 305. It is understood that the marking is merely mentioned as an example of the feature to be identified, and that other types of features may also be used. Possible features have been discussed above and are shown in FIGS. 5-7 and 9. Exemplary features for identification by the trained algorithm 305 may comprise, for example, connectors, markings on connectors, in particular codes, locking devices on cable ends or connectors, and in particular the state of such a locking device, as explained in connection with FIGS. 5-7. Other exemplary features may include, for example, contact tongues of connectors and, in particular, the positions of the contact tongues in the connectors, as explained in connection with FIG. 9.

The evaluation device 304 may, for example, generate a positive control signal 306 if exactly one of the two cable ends 391-1, 391-2 has a marking or a predetermined feature. In this regard, in one embodiment, the marking may be formed such that it is only visible in one of the two images 303-1, 303-2 of one of the cable ends 391-1, 391-2 at a time. In such an embodiment, the evaluation device 304 may generate the positive control signal 306, for example, only when the marking has been identified in only one of the images 303-1, 303-2. In other embodiments, the evaluation device 304 may generate a positive control signal 306 if both cable ends 391-1, 391-2 have a mark or a predetermined feature. Again, the marking may be such that it is only visible in one of two images 303-1, 303-2 of a cable end 391-1, 391-2 at a time.

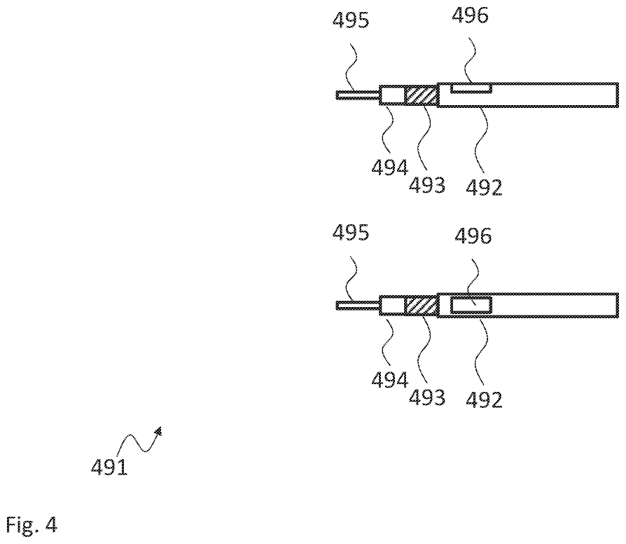

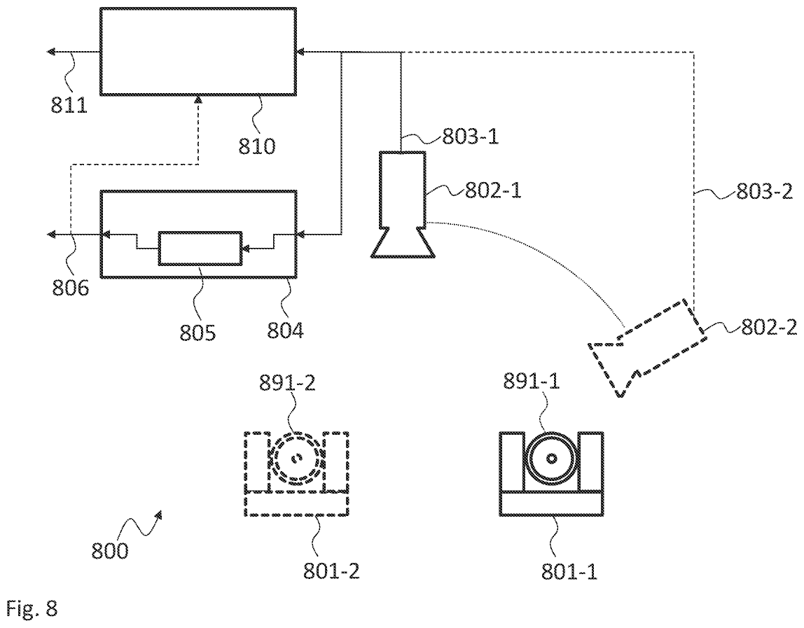

FIG. 4 shows a cable end 491 as it may be processed in one of the exemplary cable processing devices 100, 200, 300, 800 described above in FIG. 1, 2, or 3 or described in more detail below in FIG. 8, in a side view (top) and a top view (bottom). The cable end 491 corresponds to the cable end 191 shown in FIG. 1. Consequently, the cable end 491 has a sheath 492 which encloses a braided shield 493 arranged on an insulator 494. The insulator 494 encloses the conductor 495 of the cable.

On the sheath 492 of the cable, by way of example only, is a rectangular mark 496 representing the feature to be identified by the trained algorithm. It is understood that other shapes of the mark 496 are also possible.

It is further understood that the marking 496 can be used as the feature to be identified on other types of cables, i.e., not only on coaxial cables. For example, such marking 496 may also be used in connection with multi-core data cables.

FIG. 5 shows another cable end 591 as can be processed in one of the exemplary cable processing devices 100, 200, 300, 800 described above in FIG. 1, 2, or 3 or in more detail below in FIG. 8.

Unlike the cable end 491, the cable end 591 does not have a marking. In contrast, in the case of the cable end 591, the feature to be identified is provided by a connector 597. Consequently, in such an embodiment, the trained algorithm is trained to identify whether or not the connector 597 is present at the cable end.

The connector 597 is a circular connector, which is why the cable end 591 is not shown in two different views. It is understood that any other type of connector may be provided instead of a circular connector.

In another embodiment, a plug may be mounted on the cable end 591. However, in this embodiment, this plug need not be the feature to be identified. Rather, a marking may be provided on the plug that represents the feature to be identified. In such an embodiment, the mark on the connector is recognized by the trained algorithm.

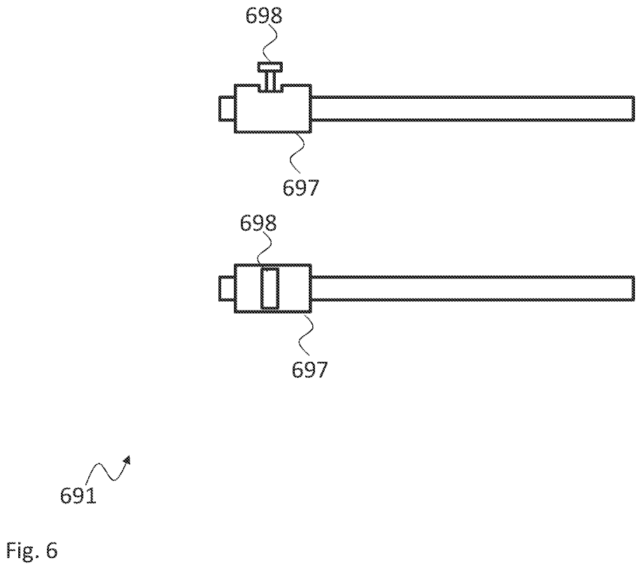

FIG. 6 shows yet another cable end 691 as may be processed in one of the cable processing devices 100, 200, 300, 800 described above in FIG. 1, 2, or 3 or described below in FIG. 8 by way of example. A connector 697 is provided at the cable end 691, but this connector is not the feature to be identified. Rather, the connector 697 includes a locking device 698, in this case a secondary locking device. The locking device 698 has a web from which pins 699 extend into the plug 697. These pins 699 positively engage the contacts of the connector 697, thereby securing them from slipping out of the connector 697.

In FIG. 6, the locking device 698 is shown in the open state, and the pins 699 are not fully recessed in the plug 697.

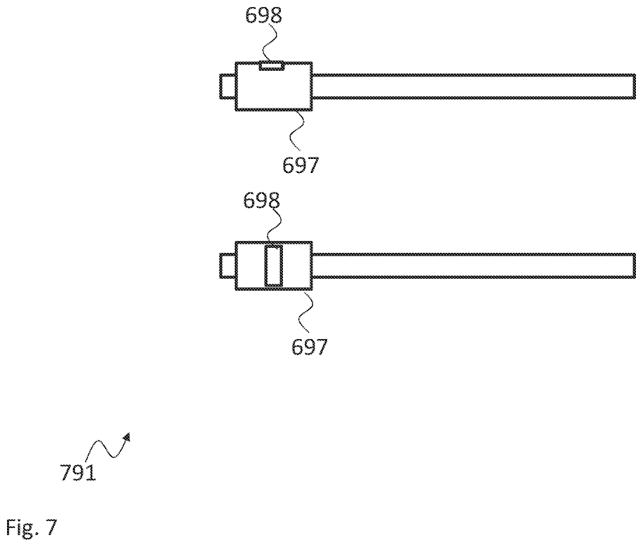

FIG. 7 shows the cable end 691 in a locked state, in which the pins 699 are fully recessed into the connector 697. The locking device 698 can be locked, for example, by pushing it into the connector 697.

In one embodiment, if the feature to be identified is formed by the locking device 698, the trained algorithm may be trained to detect the presence or absence of the locking device 698.

In another embodiment, the trained algorithm may be trained to detect the state of the locking device 698, i.e., whether it is open or locked.

For better understanding, the reference signs of FIGS. 1 to 7 are also used in the following description of the method-related FIG. 8.

FIG. 8 shows another embodiment of a cable processing device 800. The cable processing device 800 is based on the cable processing device 300. Consequently, the cable processing device 800 comprises a first receiving device 801-1 for receiving a cable end 891-1, a second receiving device 801-2 for receiving a second cable end 891-2, a first camera 802-1, a second camera 802-2, and an evaluation device 804. The evaluation device 804 further comprises a trained algorithm 805. The second camera 802-2 and the second receiving device 801-2 are merely optional, and the cable processing device 800 may further comprise only one camera 802-1 and/or one receiving device 301-1. Consequently, the cable processing device 800 may correspond to any of the cable processing devices 100, 200, 300 with respect to the elements disclosed herein. Therefore, the above explanations regarding the cable processing devices 100, 200, 300 apply analogously to the cable processing device 800.

The cable processing device 800 further comprises an image processing device 810. The image processing device 810 is arranged in parallel with the evaluation device 804 and receives images 803-1, 803-2 from the first camera 802-1 and, if present, from the second camera 802-2 in parallel with the evaluation device 804.

The evaluation device 804 evaluates the images 803-1, 803-2 as already described above in connection with FIGS. 1-3. Consequently, the evaluation device 804 applies the trained algorithm 805 to the images 803-1, 803-2 and generates a control signal 806 based on a result output from the trained algorithm 805. In particular, it is provided that the evaluation device 804 applies the trained algorithm to the directly captured images 803-1, 803-2 or to a partial section of each of the directly captured images 803-1, 803-2. In particular, it may be provided that the evaluation device 804 does not apply any further image processing to the image 803.

The trained algorithm 805 may comprise, for example, a neural network, in particular a convolutional neural network. The trained algorithm 805, in particular the neural network, may be formed and trained to identify a predetermined feature in the images 803-1, 803-2 and output a positive result if the predetermined feature is appropriately identifiable. A mark may be provided on the sheath of at least one of the cable ends 891-1, 891-2, wherein such mark may represent the feature to be identified by a trained algorithm 805. It is understood that such a marking is merely exemplified as a feature to be identified, and that other types of features may also be used. Possible features have been discussed above and are shown in FIGS. 5-7 and 9. Exemplary features for identification by the trained algorithm 805 may comprise, for example, connectors, markings on connectors, in particular codes, locking devices on cable ends or connectors, and in particular the state of such a locking device, as explained in connection with FIGS. 5-7. Other exemplary features may include, for example, contact tongues of connectors and, in particular, the positions of the contact tongues in the connectors, as explained in connection with FIG. 9.

The image processing device 810 evaluates the received images 803-1, 803-2 independently of the evaluation device 804 and autonomously and generates an image processing signal 811, in particular exactly one single image processing signal 811, which represents a kind of second control signal. The image processing signal 811 can be evaluated in a corresponding processing system for cables as a second signal in parallel with the control signal 806, which indicates whether the respective cable is free of defects or not. Such a processing system for cables can, for example, only identify a cable as fault-free if both the control signal 806 and the image processing signal 811 identify a fault-free cable.

The combination of the two signals, i.e., the control signal 806 and the image processing signal 811, may also be performed in the image processing device 810. For this purpose, the evaluation device 804 may provide the control signal 806 to the image processing device 810 (shown in dashed lines). The image processing device 810 may, for example, perform a logical AND operation on the control signal 806 and the image processing signal 811, and output the AND-operated signal to the cable processing device.

The image processing device 810 may evaluate the images 803-1, 803-2 according to predetermined criteria and perform, for example, pattern recognition, edge detection, or other functions of known image processing systems that, in particular, do not use artificial intelligence for image evaluation. The image processing device 810 may consequently evaluate the received images 803-1, 803-2 for the presence of other features, in particular also multiple features, than the evaluation device 804.

It may be provided that the image processing device 810 processes the directly captured images 803-1, 803-2 or partial sections of the directly captured images 803-1, 803-2. For providing the partial section of the directly recorded images 803-1, 803-2, an intermediate program (the image processing software, in particular ‘Eye Vision Technology’ (EVT)) can still be connected between cameras 802-1, 802-2 and the image processing device 810, the sole object of which is to crop the directly recorded images 803-1, 803-2 and to forward only a defined section as a partial section or several defined partial sections in succession to the image processing device 810. This object of cropping a partial section from the directly captured images 803-1, 803-2 can also be performed within the image processing device 810. However, it is understood that the directly captured images 803-1, 803-2, not only a partial section, may also be evaluated in the image processing device 810. A single intermediate program may be provided which performs cropping of the immediately captured images 803-1, 803-2 for both the image processing device 810 and the evaluation device 804. If the intermediate program is integrated in the image processing device 810, the latter can provide the respective image crops to the evaluation device 804.

In a further embodiment, the trained algorithm 805 in the evaluation device 804 may be trained to replace the image processing device 810 and additionally analyze the features in the images 803-1, 803-2 that the image processing device 810 analyzes as described above. Such a trained algorithm 805 outputs a positive control signal 806 only if all features in the images 803-1, 803-2 have been positively checked.

FIG. 9 shows still another cable end 991 as may be processed in one of the exemplary cable processing devices 100, 200, 300, 800 described above in FIG. 1, 2, 3 or 8.

The cable end 991 is shown in a frontal view of the longitudinal axis of the cable end 991 and has a plug 997 in which an insulator 994 with four openings 979-1, 979-2, 979-3, 979-4 is arranged. Such a connector 997 may be, for example, an HSD (“High Speed Data”) connector. In a properly assembled connector 997, there are two contact tongues 980-1, 980-2, 980-3, 980-4 in each of the four openings 979-1, 979-2, 979-3, 980-4, 980-5, 980-6, 980-7. It is understood that the number of two contact tongues 980-1, 980-2, 980-3, 980-4, 980-5, 980-6, 980-7 is selected merely by way of example and that more than two contact tongues 980-1, 980-2, 980-3, 980-4, 980-5, 980-6, 980-7 may be present in any of the four openings 979-1, 979-2, 979-3, 979-4. Also understood is that fewer or more than four openings 979-1, 979-2, 979-3, 979-4 may be provided.

For testing the cable end 991, the trained algorithm may be trained to detect whether a corresponding number of contact tongues 980-1, 980-2, 980-3, 980-4, 980-5, 980-6, 980-7, e.g., two here, are present in each of the four openings 979-1, 979-2, 979-3, 979-4.

The trained algorithm may be trained to recognize, in each case for the image of a single one of the four openings 979-1, 979-2, 979-3, 979-4, i.e., a corresponding section of an overall image of the cable end 991, whether the corresponding number of contact tongues 980-1, 980-2, 980-3, 980-4, 980-5, 980-6, 980-7 is present in the respective opening 979-1, 979-2, 979-3, 979-4. The corresponding sections of the overall image can be generated, for example, by an intermediate program as described earlier.

The results of the trained algorithm for all four openings 979-1, 979-2, 979-3, 979-4 can then be abstracted to an overall result and output as a control signal. All partial results can be linked by means of a logical AND operation. A positive overall result is therefore only output if all partial results are positive.

As can be seen in FIG. 9, only one contact tongue 980-7 is arranged in the right opening 979-4 of the four openings 979-1, 979-2, 979-3, 979-4. Consequently, the trained algorithm would detect two contact tongues 980-1, 980-2, 980-3, 980-4, 980-5, 980-6 for each of the three openings 979-1, 979-2, 979-3 and identify them as being free of defects. However, the trained algorithm would only detect one contact tongue 980-7 in the fourth opening 979-4 and thus identify it as non-faulty or faulty. The overall result output would thus be negative and the cable end 991 would be evaluated as defective.

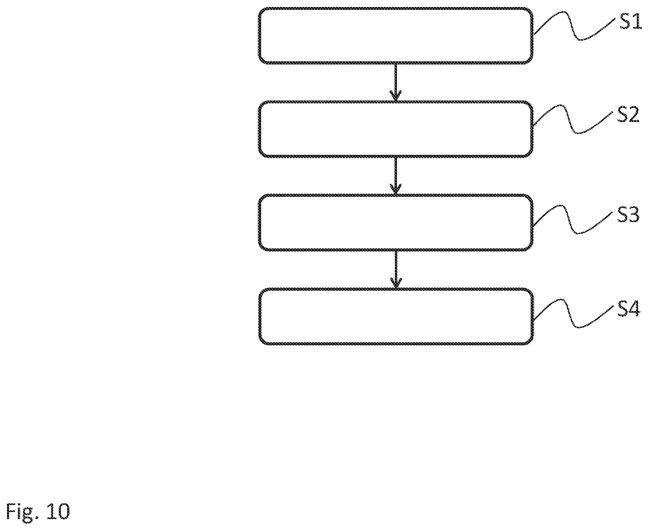

FIG. 10 shows a flow chart of a method for automatic processing of cables 190.

In a first step S1, at least one cable end 191, 291-1, 291-2, 391-1, 391-2, 491, 591, 691, 891-1, 891-2, 991 of a cable 190 is fixed in a predetermined position. In step S2, at least one image 103, 203, 303-1, 303-2, 803-1, 803-2 of the at least one cable end 191, 291-1, 291-2, 391-1, 391-2, 491, 591, 691, 891-1, 891-2, 991 is captured. In step S3, a trained algorithm 105, 205, 305, 805 is applied to the at least one image 103, 203, 303-1, 303-2, 803-1, 803-2. In particular, it is provided that the application of the trained algorithm 105, 205, 305, 805 in step S3 is directly provided, without any further intermediate steps, with the image 103, 203. 303-1, 303-2 of the at least one cable end previously captured in step S2. Finally, in step S4, a control signal 106, 206, 306, 806 is generated and output based on at least one result output from the trained algorithm 105, 205, 305, 805.

The trained algorithm 105, 205, 305, 805 mentioned above with reference to the embodiments of FIGS. 1, 2 and 3 may have, for example, a neural network, in particular a convolutional neural network. Such a trained algorithm 105, 205, 305, 805 may, for example, identify a predetermined feature 196, 496 in each of the at least one image 103, 203, 303-1, 303-2, 803-1, 803-2 and output a positive result if the predetermined feature 196, 496 is identifiable in the image 103, 203, 303-1, 303-2, 803-1, 803-2.

In one embodiment, images 103, 203, 303-1, 303-2, 803-1, 803-2 may be captured either in a top view of the respective cable end 191, 291-1, 291-2, 391-1, 391-2, 491, 591, 691, 891-1, 891-2, 991 or in a perspective view of the respective cable end 191, 291-1, 291-2, 391-1, 391-2, 491, 591, 691, 891-1, 891-2, 991. In another embodiment, images 103, 203, 303-1, 303-2, 803-1, 803-2 may be captured both in a top view of the respective cable end 191, 291-1, 291-2, 391-1, 391-2, 491, 591, 691, 891-1, 891-2, 991 and in a perspective view of the respective cable end 191, 291-1, 291-2, 391-1, 391-2, 491, 591, 691, 891-1, 891-2, 991.

In one embodiment, the predetermined feature 196, 496 may include a marker at the cable end 191, 291-1, 291-2, 391-1, 391-2, 491, 591, 691, 891-1, 891-2, 991. In such an embodiment, the trained algorithm 105, 205, 305, 805 may be trained to identify the marker at the cable end 191, 291-1, 291-2, 391-1, 391-2, 491, 591, 691, 891-1, 891-2, 991. A positive control signal 106, 206, 306, 806 may be output, in particular, when the mark at exactly one cable end 191, 291-1, 291-2, 391-1, 391-2, 491, 591, 691, 891-1, 891-2, 991 is identified in at least one of images 103, 203, 303-1, 303-2, 803-1, 803-2. An error signal may be output if the marker is not identified at exactly one cable end 191, 291-1, 291-2, 391-1, 391-2, 491, 591, 691, 891-1, 891-2, 991 in at least one of images 103, 203, 303-1, 303-2, 803-1, 803-2.

In another embodiment, the predetermined feature 196, 496 may include a locking device 698, in particular a contact locking device 698. The trained algorithm 105, 205, 305, 805 may be trained to identify the presence of the locking device 698 at the cable end 191, 291-1, 291-2, 391-1, 391-2, 491, 591, 691, 891-1, 891-2, 991. In particular, a positive control signal 106, 206, 306, 806 may be output when the interlock device 698 is identified in at least one of the images 103, 203, 303-1, 303-2, 803-1, 803-2. An error signal may be output if the predetermined marker is not identified in at least one of images 103, 203, 303-1, 303-2, 803-1, 803-2.

In yet another embodiment, the predetermined feature 196, 496 may identify the state of a locking device 698, particularly a contact locking device 698. The trained algorithm 105, 205, 305, 805 may be trained to identify the state of the interlock device 698 at the cable end 191, 291-1, 291-2, 391-1, 391-2, 491, 591, 691, 891-1, 891-2, 991. A positive control signal 106, 206, 306, 806 may be output when the state of the locking device 698 is identified as a locked state in at least one of images 103, 203, 303-1, 303-2, 803-1, 803-2. An error signal may be output if the state is not identified as a locked state. Alternatively, an error signal may be output if the state of the locking device 698 is identified as a locked state in at least one of images 103, 203, 303-1, 303-2, 803-1, 803-2. A positive control signal 106, 206, 306, 806 may be output when the state is not identified as a locked state.

Since the devices and methods described in detail above are examples of embodiments, they may be modified in a customary manner by those skilled in the art to a wide extent without departing from the scope of the invention. In particular, the mechanical arrangements and the proportions of the individual elements with respect to each other are merely exemplary.

LIST OF REFERENCES

| | |
|---|---|
| 100, 200, 300, 800 | cable processing device |
| 101, 201-1, 201-2, 301-1, 301-2 | receiving device |
| 801-1, 801-2 | receiving device |
| 102, 202, 302-1, 302-2, 802-1, 802-2 | image recording device |
| 103, 203, 303-1, 303-2, 803-1, 803-2 | image |
| 104, 204, 304, 804 | evaluation device |
| 105, 205, 305, 805 | trained algorithm |
| 106, 206, 306, 806 | control signal |
| 810 | image processing device |
| 811 | image processing signal |
| 190 | cable |
| 191, 291-1, 291-2, 391-1, 391-2 | cable end |
| 491, 591, 691, 891-1, 891-2, 991 | cable end |
| 192, 492 | sheath |
| 193, 493 | shielding |
| 194, 494, 994 | insulator |
| 195, 495 | conductor |
| 196, 496 | characteristic |
| 597, 697, 997 | connector |
| 698 | locking device |
| 699 | pin |
| 979-1, 979-2, 979-3, 979-4 | opening |
| 980-1, 980-2, 980-3, 980-4, 980-5 | contact tongue |
| 980-6, 980-7 | contact tongue |
| S1, S2, S3, S4 | method steps |

What is claimed is:

1. A cable processing device comprising:
a first receiving device adapted to receive a first cable end of a cable and fix the first cable end in a predetermined position;
an image recording device which is adapted to capture at least one image of the first cable end; and
an evaluation device which is adapted to apply a trained algorithm to the at least one image, and to generate and output a control signal based on a result output by the trained algorithm; and
wherein the trained algorithm is adapted to identify a predetermined feature in the at least one image, respectively, and to output a positive result when the predetermined feature is identifiable in the image.

2. The cable processing device of claim 1, comprising:
a second receiving device adapted to receive and fix a second cable end of the cable in a predetermined position,
wherein the image recording device is further adapted to capture at least one image of the second cable end.

3. The cable processing device of claim 1, wherein the image recording device comprises a first camera, which is configured to capture images in a top view of the first cable end.

4. The cable processing device of claim 3, wherein the image recording device comprises a second camera adapted to capture images in a perspective view of the first cable end.

5. The cable processing device of claim 1, wherein the trained algorithm comprises a convolutional neural network.

6. The cable processing device of claim 1, wherein the predetermined feature comprises a marker at the first cable end and the trained algorithm is trained to identify the marker at the first cable end.

7. The cable processing device of claim 6, wherein the evaluation device is adapted to output a positive control signal when the marker is at exactly the first cable end in the least one image, and to output an error signal if the marker is not identified at exactly the first cable end in the least one image.

8. The cable processing device of claim 1, wherein the predetermined feature comprises a contact locking device, and the trained algorithm is trained to identify a presence of the contact locking device at the first cable end.

9. The cable processing device of claim 8, wherein the evaluation device is adapted to output a positive control signal when the contact locking device is in the at least on image, and to output an error signal if the contact locking device is not identified in the at least on image.

10. The cable processing device of claim 1, wherein the predetermined feature identifies a state of a locking device, and the trained algorithm is trained to identify the state of the locking device at the first cable end.

11. The cable processing device of claim 10, wherein at least one of:
wherein the evaluation device is adapted to output a positive control signal when the state of the locking device in the at least on image is identified as a locked state, and to output an error signal when the state is not identified as a locked state, or
wherein the evaluation device is adapted to output an error signal when the state of the locking device is identified as a locked state in the at least on image and to output a positive control signal when the state is not identified as a locked state.

12. A method for automatically processing cables, comprising:
fixing at least one cable end of a cable in a predetermined position;
capturing at least one image of the at least one cable end;
applying a trained algorithm to the at least one image, wherein the trained algorithm is adapted to recognize a predetermined feature in the at least one image and to output a positive result when the predetermined feature is identifiable in the image; and
generating and outputting a control signal based on at least one result output from the trained algorithm.

13. The method of claim 12, wherein at least one of:
wherein the at least one image is taken from a top view of the at least one cable end, or
wherein the at least one image is taken in a perspective view of the at least one cable end.

14. The method of claim 12, wherein the predetermined feature comprises a mark at the at least one cable end and the trained algorithm is trained to identify the mark at the at least one cable end,
wherein, a positive control signal is output, when the mark is identified at exactly the at least one cable end in the at least one image, and an error signal is output, when the mark is not identified at exactly the at least one cable end in the at least one image.

15. The method of claim 12, wherein said predetermined feature comprises a locking device and the trained algorithm is trained to identify a presence of the locking device at the at least one cable end, wherein a positive control signal is output when the locking device is identified in the at least one image, and an error signal is output when the locking device is not identified in the at least one image.

16. The method of claim 12, wherein the predetermined feature identifies a state of a locking device and the trained algorithm is trained to identify the state of the locking device at the at least one cable end, and at least one of:
wherein a positive control signal is output when the state of the locking device is identified in the at least one image as a locked state, and an error signal is output when the state is not identified as a locked state, or
wherein an error signal is output when the state of the locking device is identified as a locked state in the at least one image, and a positive control signal is output when the state is not identified as a locked state.

17. A non-volatile computer program product comprising instructions which, when executed by a processor, cause the processor to execute an operation, the operation comprising:
fixing at least one cable end of a cable in a predetermined position;
capturing at least one image of the at least one cable end;
applying a trained algorithm to the at least one image, wherein the trained algorithm is adapted to recognize a predetermined feature in the at least one image and to output a positive result when the predetermined feature is identifiable in the image; and
generating and outputting a control signal based on at least one result output from the trained algorithm.

18. The non-volatile computer program product of claim 17, wherein at least one of:
wherein the at least one image is taken from a top view of the at least one cable end, or
wherein the at least one image is taken in a perspective view of the at least one cable end.

19. The non-volatile computer program product of claim 17, wherein the predetermined feature comprises a mark at the at least one cable end and the trained algorithm is trained to identify the mark at the at least one cable end,
wherein, a positive control signal is output, when the mark is identified at exactly the at least one cable end in the at least one image, and an error signal is output, when the mark is not identified at exactly the at least one cable end in the at least one image.

20. The non-volatile computer program product of claim 17, wherein said predetermined feature comprises a locking device and the trained algorithm is trained to identify a presence of the locking device at the at least one cable end, wherein a positive control signal is output when the locking device is identified in the at least one image, and an error signal is output when the predetermined mark is not identified in the at least one image.
